(19) United States
(12) Patent Application Publication
(10) Pub. No.: US 2011/0276645 A1
(43) Pub. Date: Nov. 10, 2011

(54) METHOD OF AND MESSAGE SERVICE GATEWAY FOR CONTROLLING DELIVERY OF A MESSAGE SERVICE TO AN END USER

(75) Inventors: Bjorn Andersson, Guangdong (CN); Watson Jiang, Guangdong (CN); Benson Peng, Guangdong (CN); Stephen Wang, Guangdong (CN)

(73) Assignee: TELEFONKTIEBOLAGET L M ERECSSON, Stockholm (SE)

(21) Appl. No.: 13/145,024

(22) PCT Filed: Jan. 16, 2009
(86) PCT No.: PCT/CN2009/000062

§ 371 Date: Jul. 18, 2011

(51) Int. Cl. G06F 15/16

(52) U.S. Cl. 709/206

(57) ABSTRACT

A method (300, 400, 500) of and a message service gateway (204) for controlling delivery of a message service provided by a service provider application (202) as a value-added service to an end user having a device with messaging capability. The method (300, 400, 500) comprises the steps of determining which one of predefined categories the service provider application (202) is, and controlling the delivery of the message service to the end user based on the determined category of the service provider application (202). A system comprising at least the above message service gateway (204), a service provider application (202), one or both of a Short Message Service Center (SMSC) (206) and a Multimedia Message Service Center (MMSC) (208), and an end user having a device with messaging capability is also provided.

### TECHNICAL FIELD

The present invention relates generally to a message service in a telecommunication network and, more particularly, to delivery control of a message service provided by a service provider application as a value-added service to an end user in a message service gateway.

### BACKGROUND

Currently a Short Message Service (SMS) and a Multimedia Message Service (MMS) are the most popular ways of value-added services. Most of the SMS/MMS value-added services are provided by a Service Provider (SP).

In general, a network operator provides the SP with an SMS/MMS channel through which the SP can access a telecommunication network of the network operator in order to deliver an SMS/MMS value-added service to an end user having a device with messaging capability. In particular, a message service gateway included in the telecommunication network, e.g. a Parlay-X Gateway or a Message Gateway, is used as an interface for sending/receiving messages to/from the SP.

FIG. 1 schematically illustrates a portion of a typical architecture of a prior art system 100 for implementing delivery of a message service. The system 100 comprises one or more SP applications 102 developed by an SP, a Parlay-X Gateway (or a Message Gateway) 104, one or more Short Message Service Centers (SMSCs) 106, one or more Multimedia Message Service Centers (MMSCs) 108, and one or more end users having devices with messaging capability (not shown). The Parlay-X Gateway 104, the SMSCs 106, and the MMSCs 108 are included in a telecommunication network of a network operator.

The SP applications 102, for example, weather forecast applications, are coupled to the Parlay-X Gateway 104. The Parlay-X Gateway 104 is connected to the SMSCs 106 to send/receive an SMS message to/from an end user having a device with SMS messaging capability. The Parlay-X Gateway 104 is also connected to the MMSCs 108 to send/receive an MMS message to/from an end user having a device with MMS messaging capability.

A process of delivery of a message service is described below in brief. For example, an SMS/MMS message containing weather forecast information is sent by one of the SP applications 102 to the Parlay-X Gateway 104, which forwards the received SMS/MMS message to one of the SMSCs 106 or to one of the MMSCs 108 depending on the type of the SMS/MMS message. The one of the SMSCs 106 or the one of the MMSCs 108 then forwards the SMS/MMS message to the end user having a device with SMS/MMS messaging capability.

There are many ways for the settlement between an SP and a network operator. One typical way of them is that the network operator charges an end user when the end user uses the SP's service and then does the settlement with the SP periodically.

In most existing systems of the network operator, however, the SP is able to deliver an SMS/MMS message to the end user without the end user's request and confirmation, and then charge the end user directly. In this case, the end user will complain to the network operator and the satisfaction for the network operator will go down.

Current existing international standards, like Short Message Peer to Peer (SMPP), Multimedia Message 7 (MM7), Parlay-X, Push Access Protocol (PAP), are not designed for the purpose of delivery control of a message service and hence can not solve the delivery control problem as stated above.

A UK patent application GB 2437776A discloses a method of providing routing information for routing a message to a destination mobile entity. Although the method has delivery control of a value-added service directed to the destination mobile entity, it has a number of disadvantages. For example, the method has a limited range of applicability. Since in the method the destination mobile entity has to subscribe to a value-added service to achieve delivery control of the value-added service, the method is not applicable to the case that the destination mobile entity does not subscribe to the value-added service. Moreover, the method requires changing the implementation of an SMSC.

### SUMMARY

Therefore, it is the object of the present invention to address the above disadvantages by providing a method of and a message service gateway for controlling delivery of a message service provided by a service provider application as a value-added service to an end user to improve user satisfaction for a network operator.

According to one aspect of the invention, there is provided a method of controlling delivery of a message service provided by a service provider application as a value-added service to an end user having a device with messaging capability in a message service gateway. The method comprises the steps of determining which one of predefined categories the service provider application is, and controlling the delivery of the message service to the end user based on the determined category of the service provider application.

In an embodiment of the method, in the case that the determined category of the service provider application is a one-time-use application included in the predefined categories, the step of controlling the delivery of the message service to the end user comprises the step of allowing the delivery of the message service to the end user only if a prior request for the message service from the end user is received.

In an embodiment of the method, in the case that the determined category of the service provider application is a multiple-time-use application included in the predefined categories, the step of controlling the delivery of the message service to the end user comprises the steps of creating a User Usage Record (UUR) of the end user in a user usage database if a request for the message service from the end user is received for the first time; and allowing the delivery of the message service to the end user only if there is the UUR of the end user in the user usage database.

Preferably, the UUR contains at least a session ID generated by the message service gateway to identify the request for the message service from the end user, a user ID identifying the end user, an application ID identifying the service provider application, a delivery count representing a total number of messages which have been delivered to the end user by the service provider application, and a date and time when the UUR of the end user is created. More preferably, the user ID is a Mobile Station international ISDN number (MSISDN) of the end user.

In an embodiment, the method further comprises the step of removing the UUR of the end user from the user usage database if the end user does not use the message service within a predefined time period.

In an embodiment, the method further comprises the step of removing the UUR of the end user from the user usage database if the service provider application relating to the UUR is removed.

In an embodiment, the method further comprises the step of removing the UUR of the end user from the user usage database through invoking an available interface by the service provider application.

In an embodiment, the method further comprises the step of charging the end user for the message service upon the successful delivery of the message service to the end user.

Preferably, the message service comprises one or both of an SMS and an MMS.

According to another aspect of the invention, there is provided a message service gateway for controlling delivery of a message service provided by a service provider application as a value-added service to an end user having a device with messaging capability. The message service gateway comprises a controlling component configured to determine which one of predefined categories the service provider application is and control the delivery of the message service to the end user based on the determined category of the service provider application, and a user usage database coupled to the controlling component and configured to store the UUR of the end user.

In an embodiment of the message service gateway, the controlling component is further configured to, in the case that the determined category of the service provider application is a one-time-use application included in the predefined categories, allow the delivery of the message service to the end user only if a prior request for the message service from the end user is received.

In an embodiment of the message service gateway, the controlling component is further configured to, in the case that the determined category of the service provider application is a multiple-time-use application included in the predefined categories, create a UUR of the end user in the user usage database if a request for the message service from the end user is received for the first time, and allow the delivery of the message service to the end user only if there is the UUR of the end user in the user usage database.

Preferably, the UUR contains at least a session ID generated by the message service gateway to identify the request for the message service from the end user, a user ID identifying the end user, an application ID identifying the service provider application, a delivery count representing a total number of messages which have been delivered to the end user by the service provider application, and a date and time when the UUR of the end user is created.

In an embodiment, the message service gateway further comprises an interface available to the service provider application.

In an embodiment, the message service gateway further comprises a charging component coupled to the controlling component and configured to charge the end user for the message service upon the successful delivery of the message service to the end user.

Preferably, the message service comprises one or both of an SMS and an MMS.

Preferably, the message service gateway is one of a Message Gateway and a Parlay-X Gateway.

According to yet another aspect of the invention, there is provided a system comprising at least the message service gateway as stated above, a service provider application, one or both of an SMSC and an MMSC, and an end user having a device with messaging capability.

### BRIEF DESCRIPTION OF THE DRAWINGS

The above and other aspects, features and advantages of the present invention will be more apparent from the following more particular description thereof, presented in conjunction with the accompanying drawings, in which:

FIG. 1 schematically illustrates a portion of a typical architecture of a prior art system for implementing delivery of a message service;

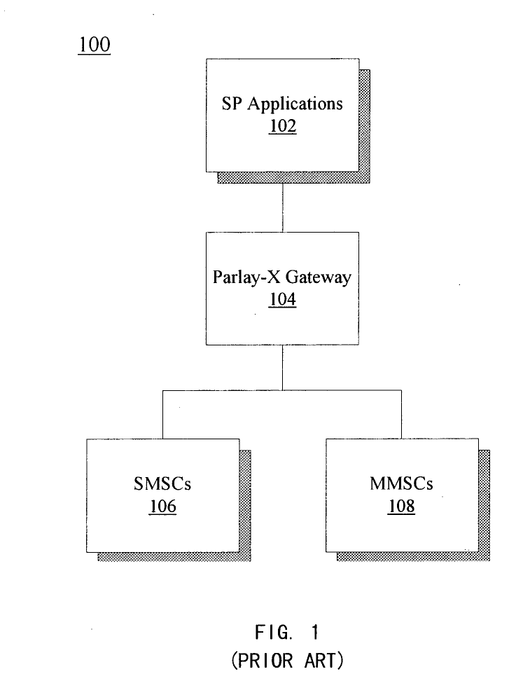

FIG. 2 is a schematic block diagram of a portion of a system in which embodiments of the present invention are implemented;

FIG. 3 is a sequence diagram illustrating a process of controlling delivery of a message service provided by a one-time-use application in accordance with an embodiment of the present invention;

FIG. 4 is a sequence diagram illustrating a process of the first use of a message service provided by a multiple-time-use application in accordance with an embodiment of the present invention; and

FIG. 5 is a sequence diagram illustrating a process of the non-first use of the message service provided by the multiple-time-use application in accordance with the embodiment of the present invention.

Corresponding reference characters indicate corresponding components throughout the several views of the drawings.

### DETAILED DESCRIPTION

The embodiments set forth below represent the necessary information to enable those skilled in the art to practice the invention and illustrate the best mode of the practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

Throughout the description and claims of this specification, the terminology “message service gateway” includes, but is not limited to, a Message Gateway, a Parlay-X Gateway, or any other type of gateway for data exchange between an SP and an SMSC/MMSC. It should be noted that embodiments of the invention are described below in the context of a Parlay-X Gateway as an example of a message service gateway.

The terminology “a device with messaging capability” includes, but is not limited to, a mobile device with messaging capability, a fixed device with messaging capability, or any other type of device with messaging capability.

The principle of the present invention is outlined first. The present invention enables network operator's system to control all the message services delivered by an SP by exposing a new message interface towards the SP and adding a user usage database. The system will reject the delivery of the message services from the SP if it does not receive a user request or even a user confirmation.

To this end, the system first determines which one of predefined categories an SP application delivering a message service as a value-added service to an end user having a device with messaging capability is, and then controls the delivery of the message service based on the determined category of the SP application. For example, the system classifies all the SP message applications into two categories: a one-time-use application and a multiple-time-use application. As indicated by its name, the one-time-use application will deliver a message service to an end user once when it receives a request from the end user. In contrast, the multiple-time-use application will deliver a message service to an end user multiple times within a future time period when it receives a request from the end user. As an example, an attribute (APP_USAGE_TYPE) is added to the network operator's application property record to differentiate between these two categories of applications.

For delivery control of the one-time-use application, the one-time-use application is allowed to deliver a Mobile Terminated (MT) message to an end user only if the end user sends a Mobile Originated (MO) message request for the application first. To support the control, a new message interface DeliverControl is defined. The new message interface carries the end user's MO request to the application in the message request, and the application puts the MT message back to the system in the message response.

For delivery control of the multiple-time-use application, a UUR of an end user will be created in a user usage database when the end user uses a message service provided by the multiple-time-use application for the first time. Then each message delivery from the application is allowed only if there is the UUR in the user usage database. As an example, a UUR contains the following basic information:
a session ID generated by the system to identify a request for a message service from an end user,
a user ID identifying the end user, e.g. a Mobile Station international ISDN number (MSISDN) of the end user,
an application ID identifying a service provider application,
a delivery count representing a total number of messages which have been delivered to the end user by the service provider application, and
a date and time when the UUR of the end user is created.

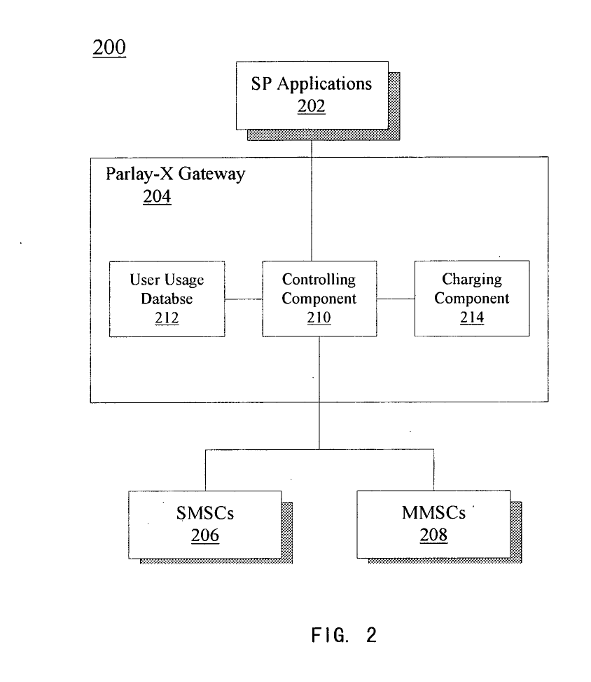

The present invention now will be described in more detail by way of example with reference to FIGS. 2-5. FIG. 2 is a schematic block diagram of a portion of a system 200 in which embodiments of the present invention are implemented. The system 200 comprises one or more SP applications 202 developed by an SP, a Parlay-X Gateway 204, one or more Short Message Service Centers (SMSCs) 206, one or more Multimedia Message Service Centers (MMSCs) 208, and one or more end users having devices with messaging capability (not shown). The Parlay-X Gateway 204 comprises a controlling component 210 and a user usage database 212 coupled to the controlling component 210. Optionally, the Parlay-X Gateway 204 comprises a charging component 214 coupled to the controlling component 210.

The controlling component 210 is coupled to the SP applications 202 and to the SMSCs 206 and the MMSCs 208, and configured to, among others, control delivery of message services provided by the SP applications 202 to the end users based on the category of the SP applications 202. The user usage database 212 is configured to store UURs of all of the end users. The charging component 214 is configured to charge the end users for the message services upon successful delivery of the messages services to the end users.

It should be understood that the controlling component 210 and the charging component 214 may comprise hardware, software, firmware, or any combination thereof. In at least one embodiment, the controlling component 210 and the charging component 214 include one or more general or special purpose microprocessors and/or digital signal processors that are programmed to carry out operations corresponding to the process steps as discussed below. Instructions may be embodied as one or more computer programs comprising stored program instructions in a storage element (e.g., memory).

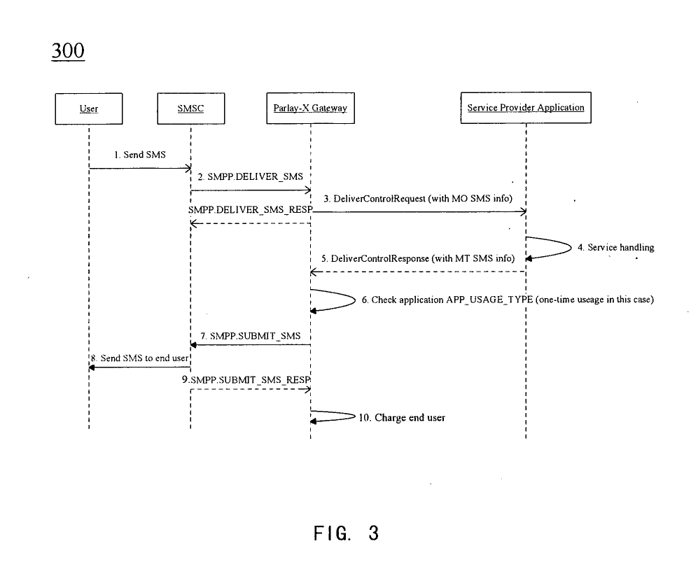

Referring to FIG. 3, there is shown a sequence diagram illustrating a process 300 of controlling delivery of a message service provided by a one-time-use application in accordance with an embodiment of the present invention. It should be understood that the process 300 is not necessarily limited to the illustrated sequence, some steps may be omitted as desired, and some steps may be performed together or otherwise in an interrelated fashion.

The process 300 is described below in conjunction with FIG. 2. The process 300 begins with step 1 in which one of the end users sends an MO SMS message carrying MO SMS information, for example, for requesting weather information of Stockholm. Then in step 2, one of the SMSCs 206 receives the MO SMS message and forwards the MO SMS message to the Parlay-X Gateway 204. This step 2 is the implementation of the request for the message service from the end user.

Then in step 3, the controlling component 210 included in the Parlay-X Gateway 204 checks the destination of the MO SMS message and forwards the MO SMS message to an appropriate one of the SP applications 202. A DeliverControl message based on Web Service techniques is used herein to support delivery control. The DeliverControl message comprises an input message (i.e. DeliverControlRequest) and an output message (i.e. DeliverControlResponse). Therefore, for step 3, the controlling component 210 forwards the MO SMS message to the appropriate SP application 202 by means of a DeliverControlRequest message carrying the MO SMS information.

Then in step 4, the appropriate SP application 202 parses the MO SMS message and finds the appropriate information. In the example, the appropriate SP application 202 finds that the user wants to get the weather information of Stockholm. Then in step 5, the appropriate SP application 202 sends an MT message to the Parlay-X Gateway 204 by means of a DeliverControlResponse message carrying MT information which will be delivered to the end user.

Then in step 6, the controlling component 210 included in the Parlay-X Gateway 204 determines whether the appropriate SP application 202 is one-time-use by checking an attribute field APP_USAGE_TYPE. The answer in the present case is YES and the process 300 proceeds to step 7 where the Parlay-X Gateway 204 sends the MT message to the one of the SMSCs 206.

Then in step 8, the one of the SMSCs 206 delivers to the end user the MT message with the MT information from the appropriate SP application 202 successfully. Then the charging component 214 included in the Parlay-X Gateway 204 charges the end user in step 10 once it receives from the one of the SMSCs 206 a response message SMMP_SUBMIT_SMS_RESP indicating the successful delivery of the MT message to the end user in step 9. The detection of the successful delivery is made when the response message SMMP_SUBMIT_SMS_RESP is received in the Parlay-X Gateway 204. Then the process 300 ends.

For a one-time-use SP application, the above embodiment adopting a new message interface DeliverControl is more efficient than a standard Parlay-X way. In the Parlay-X standard, a Parlay-X Gateway needs to upload an MO message to an SP application by using notifySmsMessage or notifyMessage and the SP application delivers an MT message to the Parlay-X Gateway by using sendSms or sendMessage, which are two rounds of request and response interaction. In contrast, for the above embodiment, uploading the MO message to the SP application and delivering the MT message to Parlay-X Gateway can be done in one round of request and response interaction.

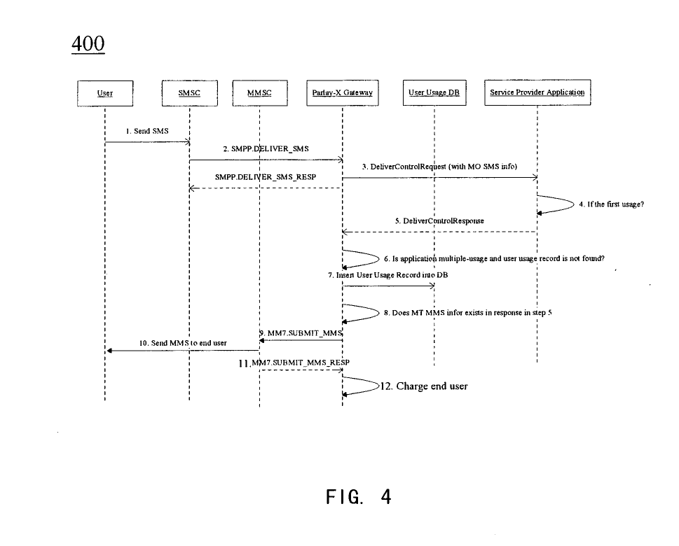

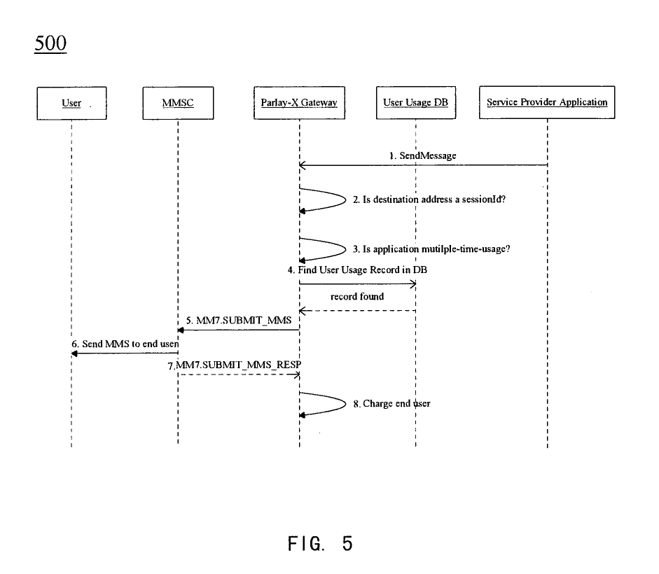

FIGS. 4 and 5 together illustrate delivery control of a message service provided by a multiple-time-use application in accordance with an embodiment of the present invention. Specifically, FIG. 4 is a sequence diagram illustrating a process 400 of the first use of the message service provided by the multiple-time-use application, and FIG. 5 is a sequence diagram illustrating a process 500 of the non-first use of the message service provided by the multiple-time-use application.

The processes 400 and 500 are described below still in conjunction with FIG. 2. The process 400 shown in FIG. 4 begins with step 1 in which one of the end users sends an MO SMS message carrying MO SMS information, for example, for requesting daily news of Stockholm. Then in step 2, one of the SMSCs 206 receives the MO SMS message and forwards the MO SMS message to the Parlay-X Gateway 204.

Then in step 3, the controlling component 210 included in the Parlay-X Gateway 204 checks the destination of the MO SMS message and forwards the MO SMS message to an appropriate one of the SP applications 202. The DeliverControl message as stated above is used herein to support delivery control. Therefore, for step 3, the controlling component 210 forwards the MO SMS message to the appropriate SP application 202 by means of a DeliverControlRequest message carrying the MO SMS information.

Then in step 4, the appropriate SP application 202 parses the MO SMS message and creates a subscription for the end user in its own database. Then in step 5, the appropriate SP application 202 sends a response message to the Parlay-X Gateway 204 by means of a DeliverControlResponse message with or without MT information which will be delivered to the end user. In the example, the appropriate SP application 202 sends an MMS message with today's daily news.

Then in step 6, the controlling component 210 included in the Parlay-X Gateway 204 determines whether the appropriate SP application 202 is multiple-time-use by checking an attribute field APP_USAGE_TYPE. The answer in the present case is YES and then the controlling component 210 determines whether there is a UUR for the end user in the user usage database 212. The answer in the present case is NO to demonstrate that it is the first time for the end user to use the message service. Then the process 400 proceeds to step 7 where the controlling component 210 creates a UUR for the end user in the user usage database 212. Optionally, an SMS confirmation message can be sent to the end user by the Parlay-X Gateway 204 before the UUR is created. If the end user replies YES by an SMS message, then the UUR will be created. In such a way, the delivery control of multiple-time-use applications is enhanced.

Then in step 8, the controlling component 210 determines whether there is the MT information in the response message by checking a message type field messageType therein. Some SP applications may not deliver a message to the end user immediately, and hence set the messageType to None_Message to let the Parlay-X Gateway 204 ignore the response message. In this case, the process 400 ends.

Since there is the MT information in the response message for the present case, the process 400 proceeds to step 9 where the Parlay-X Gateway 204 sends the response message (i.e. the MMS message with today's daily news) to the one of the MMSCs 208. Then in step 10, the one of the MMSCs 208 delivers the MMS message to the end user successfully. Then the charging component 214 included in the Parlay-X Gateway 204 charges the end user in step 12 once it receives from the one of the MMSCs 208 a response message MM7_SUBMIT_MMS_RESP indicating the successful delivery of the MMS message to the end user in step 11. The detection of the successful delivery is made when the response message MM7_SUBMIT_MMS_RESP is received in the Parlay-X Gateway 204. Then the process 400 ends.

Turning to FIG. 5, the process 500 begins with step 1 in which one of the SP applications 202 sends to the Parlay-X Gateway 204 a message with MT information, for example, an MMS message with daily news of another day. It is noted that in this case an SP application can deliver a message in a standard way in Parlay-X protocol by using SendSms for an SMS message or SendMessage for an MMS message. However, the destination address should be set to a session ID which the SP application gets from a DeliverControlRequest message.

Then in step 2, the controlling component 210 included in the Parlay-X Gateway 204 determines whether the destination address of the message is a session ID (i.e. an address with a prefix “session:”). The answer in the present case is YES and then the process 500 proceeds to step 3 where the controlling component 210 determines whether the appropriate SP application 202 is multiple-time-use by checking an attribute field APP_USAGE_TYPE. The answer in the present case is YES and then in step 4 the controlling component 210 determines whether there is a UUR with the same session ID in the user usage database. The answer in the present case is YES and then the controlling component 210 increments the delivery count in the UUR.

Then in step 5, the Parlay-X Gateway 204 sends an MT message from the SP application 202 to a service enabler. In the example, the Parlay-X Gateway 204 sends the MMS message with daily news of another day to the one of the MMSCs 208. Then in step 6, the one of the MMSCs 208 delivers the MMS message to the end user successfully. Then the charging component 214 included in the Parlay-X Gateway 204 charges the end user in step 8 once it receives from the one of the MMSCs 208 a response message MM7_SUBMIT_MMS_RESP indicating the successful delivery of the MMS message to the end user in step 7. The detection of the successful delivery is made when the response message MM7_SUBMIT_MMS_RESP is received in the Parlay-X Gateway 204. Then the process 500 ends.

The message interface DeliverControl supports different content type in one message. For example, an SP application can send an MMS message in response to an SMS message for requesting a subscription, which is shown in the above embodiment of the present invention. From business point of view, this is more flexible for meeting the SP's requirements.

It should be noted that the session ID is a unique identifier of the DeliverControl session. Hence, an MSISDN of the end user is not exposed to the SP, which avoids advertisement spam to the end user from an SP.

In addition, the number of UURs may increase quickly if there are thousands of SP applications and end users use them frequently. So a cleanup mechanism is important for a better system performance. There are different ways to cleanup the UURs.

In a first exemplary embodiment, the controlling component 210 checks the user usage periodically (e.g. monthly). If an end user does not use a message service within a predefined time period (like 180 days), the controlling component 210 will remove the UUR of the end user in the user usage database. To facilitate this, the following fields can be added to an SP application:
Is Periodic, which indicates whether an SP application is used by an end user periodically;
Periodic Type, which indicates the type of a periodic SP application, like monthly, weekly, etc; and
Max Usage Days, which indicates, for a non-periodic SP application, the maximum effective usage days after the first UUR is created.

In a second exemplary embodiment, if an SP application relating to a UUR is removed, the controlling component 210 will remove the UUR in the user usage database.

In a third exemplary embodiment, the Parlay-X Gateway 204 can expose an interface for the SP application so that the SP application can invoke the interface to remove the UUR from the user usage database if needed.

Throughout the description and claims of this specification, the words “comprise”, “include”, “contain”, and variations of the words, for example “comprising” and “comprises”, means “including but not limited to”, and is not intended to (and does not) exclude other components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

It will be understood that the foregoing description of the embodiments of the invention has been presented for purposes of illustration and description. This description is not exhaustive and does not limit the claimed invention to the precise forms disclosed. Modifications and variations are possible in light of the above description or may be acquired from practicing the invention. The claims and their equivalents define the scope of the invention.

1. A method of controlling delivery of a message service provided by a service provider application as a value-added service to an end user having a device with messaging capability in a message service gateway, said method comprising the steps of:
determining which one of predefined categories the service provider application is; and
controlling the delivery of the message service to the end user based on the determined category of the service provider application,
wherein the predefined categories include a one-time-use application and a multiple-time-use application.

2. The method according to claim 1, wherein in the case that the determined category of the service provider application is the one-time-use application, the step of controlling the delivery of the message service to the end user comprises the step of allowing the delivery of the message service to the end user only if a prior request for the message service from the end user is received.

3. The method according to claim 1, wherein in the case that the determined category of the service provider application is the multiple-time-use application, the step of controlling the delivery of the message service to the end user comprises the steps of:
creating a User Usage Record (UUR) of the end user in a user usage database if a request for the message service from the end user is received for the first time; and
allowing the delivery of the message service to the end user only if there is the UUR of the end user in the user usage database.

4. The method according to claim 3, wherein the UUR contains at least a session ID generated by the message service gateway to identify the request for the message service from the end user, a user ID identifying the end user, an application ID identifying the service provider application, a delivery count representing a total number of messages which have been delivered to the end user by the service provider application, and a date and time when the UUR of the end user is created.

5. The method according to claim 4, wherein the user ID is a Mobile Station international ISDN number (MSISDN) of the end user.

6. The method according to claim 3, further comprising the step of removing the UUR of the end user from the user usage database if the end user does not use the message service within a predefined time period.

7. The method according to claim 3, further comprising the step of removing the UUR of the end user from the user usage database if the service provider application relating to the UUR is removed.

8. The method according to claim 3, further comprising the step of removing the UUR of the end user from the user usage database through invoking an available interface by the service provider application.

9. The method according to claim 1, further comprising the step of charging the end user for the message service upon the successful delivery of the message service to the end user.

10. The method according to claim 1, wherein the message service comprises one or both of a Short Message Service (SMS) and a Multimedia Message Service (MMS).

11. A message service gateway for controlling delivery of a message service provided by a service provider application as a value-added service to an end user having a device with messaging capability, said message service gateway comprising:
a controlling component configured to determine which one of predefined categories the service provider application is and control the delivery of the message service to the end user based on the determined category of the service provider application; and
a user usage database coupled to the controlling component and configured to store a User Usage Record (UUR) of the end user,
wherein the predefined categories include a one-time-use application and a multiple-time-use application.

12. The message service gateway according to claim 11, wherein the controlling component is further configured to, in the case that the determined category of the service provider application is the one-time-use application, allow the delivery of the message service to the end user only if a prior request for the message service from the end user is received.

13. The message service gateway according to claim 11, wherein the controlling component is further configured to, in the case that the determined category of the service provider application is the multiple-time-use application, create a UUR of the end user in the user usage database if a request for the message service from the end user is received for the first time, and allow the delivery of the message service to the end user only if there is the UUR of the end user in the user usage database.

14. The message service gateway according to claim 11, wherein the UUR contains at least a session ID generated by the message service gateway to identify the request for the message service from the end user, a user ID identifying the end user, an application ID identifying the service provider application, a delivery count representing a total number of messages which have been delivered to the end user by the service provider application, and a date and time when the UUR of the end user is created.

15. The message service gateway according to claim 11, further comprising an interface available to the service provider application.

16. The message service gateway according to claim 11, further comprising a charging component coupled to the controlling component and configured to charge the end user for the message service upon the successful delivery of the message service to the end user.

17. The message service gateway according to claim 11, wherein the message service comprises one or both of a Short Message Service (SMS) and a Multimedia Message Service (MMS).

18. The message service gateway according to claim 11, wherein the message service gateway is one of a Message Gateway and a Parlay-X Gateway.

19. A system comprising at least the message service gateway according to claim 11, a service provider application, one or both of a Short Message Service Center (SMSC) and a Multimedia Message Service Center (MMSC), and an end user having a device with messaging capability.
